(19) United States
(12) Patent Application Publication
(10) Pub. No.: US 2010/0231517 A1
(43) Pub. Date: Sep. 16, 2010

(54) SYSTEM AND METHOD FOR INPUTTING INFORMATION

(75) Inventor: ZHENG-HENG SUN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/422,206

(22) Filed: Apr. 10, 2009

(30) Foreign Application Priority Data
Mar. 13, 2009 (CN) 200910300821.6

(51) Int. Cl. G09G 5/08; G06F 3/048

(52) U.S. Cl. 345/163; 715/773

(57) ABSTRACT

A system for inputting information includes a computer with a safety input program, and a mouse connected to the computer. The safety input program includes an interface popup module, a signal control module, and a character output module. The interface popup module is configured for popping up an input interface after the safety input program is activated. The input interface includes a character display box and a character input box. The signal control module is configured for processing signals inputted in the character display box by the mouse, to select desired characters from the character display box, and to input the selected characters into the character input box. The character output module is configured for outputting characters input and displayed in the character input box to an input window of an application interface.

### BACKGROUND

1. Technical Field

The present disclosure relates to a system and a method for inputting information.

2. Description of Related Art

Online security is becoming a growing concern as more and more personal information is transmitted over the internet or saved in a data format in a personal computer. Even though much of the data is substantially password-protected, current technology cannot prevent hackers from spying and extracting sensitive information, such as passwords, personal identification numbers, credit card numbers, etc. At present, the sensitive information is typically inputted via a keystroke. However, there are several known methods to steal the sensitive information from a keystroke input, for example, hackers may use hardware and software keyloggers.

### BRIEF DESCRIPTION OF THE DRAWINGS

FIG. 1 is a schematic diagram of an embodiment of a system for inputting information.

FIG. 2 is a block diagram of the system of FIG. 1, in accordance with an embodiment.

FIG. 3 is a schematic diagram of an input interface of the system of FIG. 1, in accordance with an embodiment.

FIG. 4 is a flowchart of an embodiment of a method for inputting information.

FIG. 5 is a schematic diagram of a first state of an application interface of the system of FIG. 3.

FIG. 6 is a schematic diagram of a second state of the application interface of the system of FIG. 3.

### DETAILED DESCRIPTION

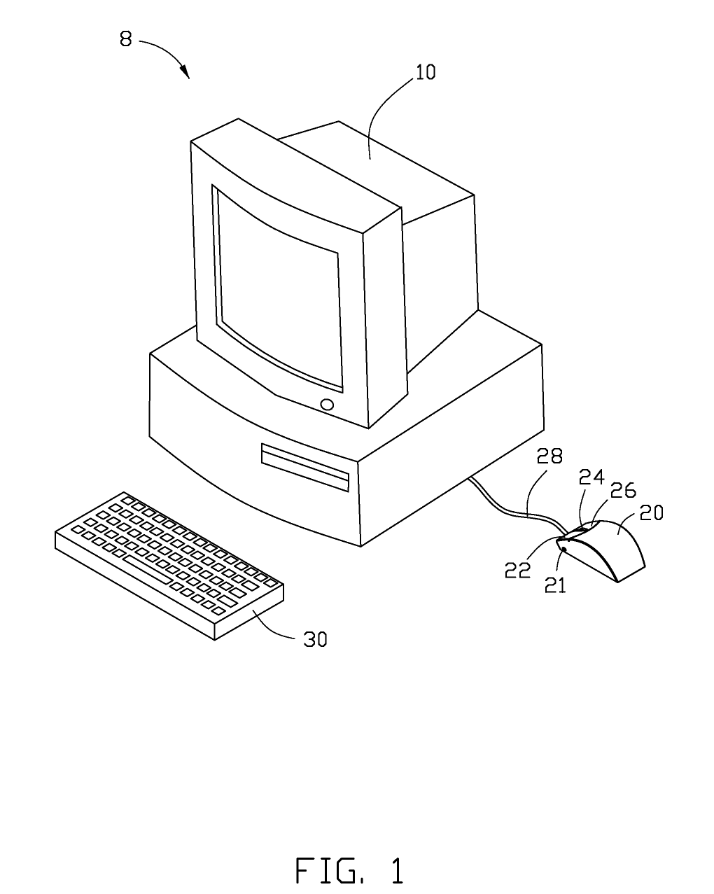

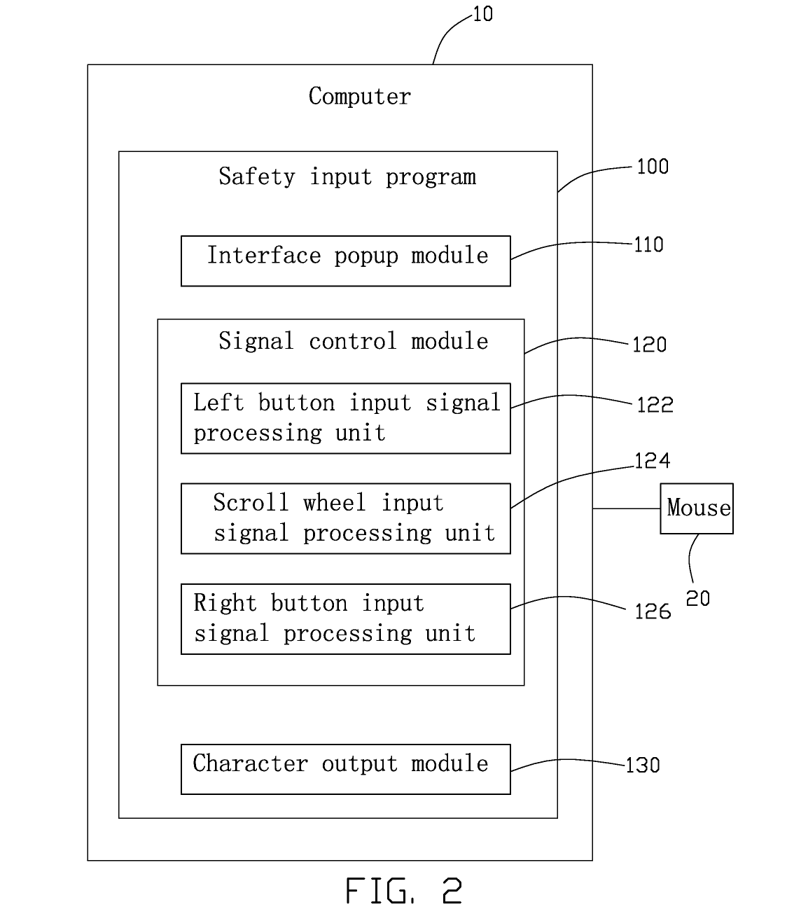

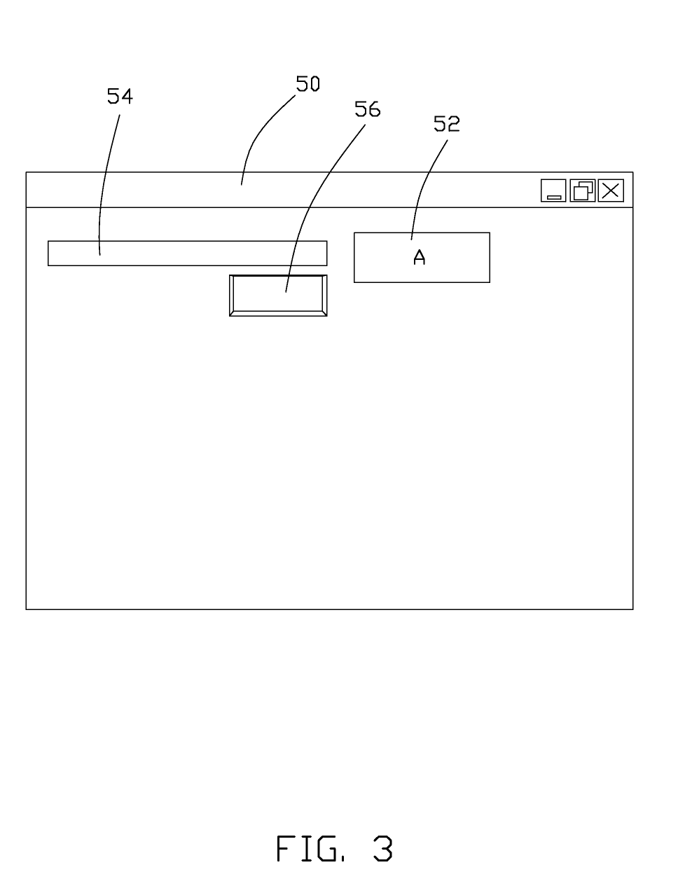

Referring to FIG. 1 to FIG. 3, an exemplary embodiment of a system 8 for inputting information includes a computer 10 with a safety input program 100, and a mouse 20 connected to the computer 10. The mouse 20 includes a switch 21, a left button 22, a scroll wheel 24, and a right button 26. The safety input program 100 is configured to provide an input interface 50 to cooperate with the mouse 20 for inputting information. The safety input program 100 includes an interface popup module 110, a signal control module 120, and a character output module 130. In one embodiment, the mouse 20 is connected to the computer 10 via a cable 28, the switch 21 is configured for activating the safety input program 100. In other embodiments, shortcut keys can be set on a keyboard 30 of the computer 10, and the safety input program 100 may be activated by the shortcut keys. Particularly, when the mouse 20 is a touch pad mouse, such as a touch pad of a notebook computer, the safety input program 100 is activated by the shortcut keys.

The input interface 50 includes a character display box 52, a character input field 54, and a submitting button 56. The character display box 52 is configured to display alphanumeric characters, such as numerals 0-9, lowercases a-z, and uppercases A-Z, and is triggered via signals generated by the mouse 20. The character input box 54 is configured to input alphanumeric characters selected from the character display box 52 by the mouse 20. The submitting button 56 is configured to enable alphanumeric characters displayed in the character input box 54 to be transmitted to an input window of an application interface, and is triggered by the mouse 20.

The interface popup module 110 is configured for popping up the input interface 50, after the safety input program 100 is activated. The signal control module 120 is configured for responding to the mouse 20 to select desired alphanumeric characters displayed in the character display box 52, and to input the selected alphanumeric characters into the character input box 54. The signal control module 120 includes a left button input signal processing unit 122, a scroll wheel input signal processing unit 124, and a right button input signal processing unit 126. The character output module 130 is configured for outputting all alphanumeric characters in the character input box 54 to an input window of an application interface, such as an input box of a web page, in response to the submitting button 56 being triggered by the mouse 20. In one embodiment, the alphanumeric characters, such as numerals 0-9, lowercases a-z, and uppercases A-Z, may appear one after the other in the character display box 52 randomly. That is, the numerals 0-9 may appear firstly and may be not follow conventional sequence from 0 to 9.

The left button input signal processing unit 122 is configured for processing the signals inputted in the character display box 52 by the left button 22. For example, the left button input signal processing unit 122 is configured to switch between different kinds of the alphanumeric characters to be displayed in the character display box 52, by clicking the character display box 52 once via the left button 22, such as switching from a numeral to a lowercase alpha character.

The scroll wheel input signal processing unit 124 is configured for processing the signals input in the character display box 52 by the scroll wheel 24. For example, the scroll wheel input signal processing unit 124 is configured to switch among different alphanumeric characters of a certain set of the alphanumeric characters to be displayed in the character display box 52 by rolling the scroll wheel 24 of the mouse 20, such as switching an alphanumeric character displayed in the character display box 52 from A to M. The scroll wheel input signal processing unit 124 is configured to input an alphanumeric character currently displayed in the character display box 52 into the character input box 54 in response to pressing down the scroll wheel 24 to select the currently displayed alphanumeric character.

The right button input signal processing unit 126 is configured for processing the signals input in the character display box 52 by the right button 26. For example, the right button input signal processing unit 126 is configured to delete a last alphanumeric character input and displayed in the character input box 54, in response to the right button 26 clicking the character display box 52. In other embodiments, each signal inputted in the character display box 52 by the mouse 20 can be set by the safety input program 100 to have other special function according to actual need.

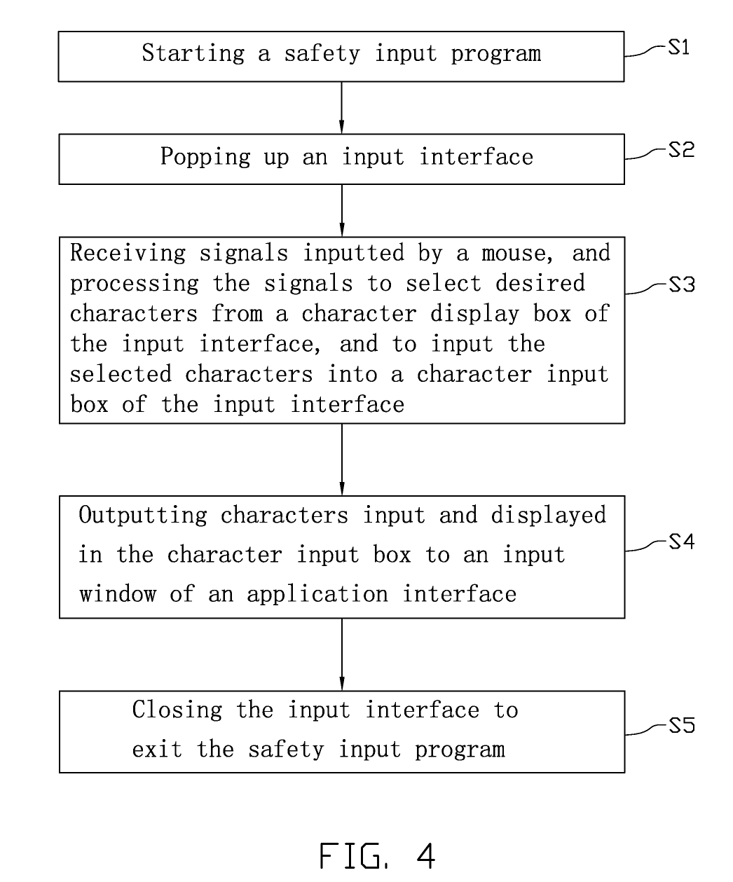

Referring to FIG. 4, a method for inputting information includes the following steps, in accordance with an embodiment.

Step S1: placing a cursor of the mouse 20 in an input window of an application interface, and activating the safety input program 100 of the computer 10 by the switch 21 of the mouse 20 or the shortcut keys of the keyboard 30.

Step S2: popping up the input interface 50 in a display of the computer 10.

Step S3: receiving signals inputted in the character display box 52 by the mouse 20, and processing the signals to select desired characters from the character display box and to input the selected characters into the character input box 54.

Step S4: single-clicking the submitting button 56 of the input interface 50 by the left button 22 to output all characters input and displayed in the character input box 54 to the input window of the application interface.

Step S5: closing the input interface 50 to exit the safety input program 100.

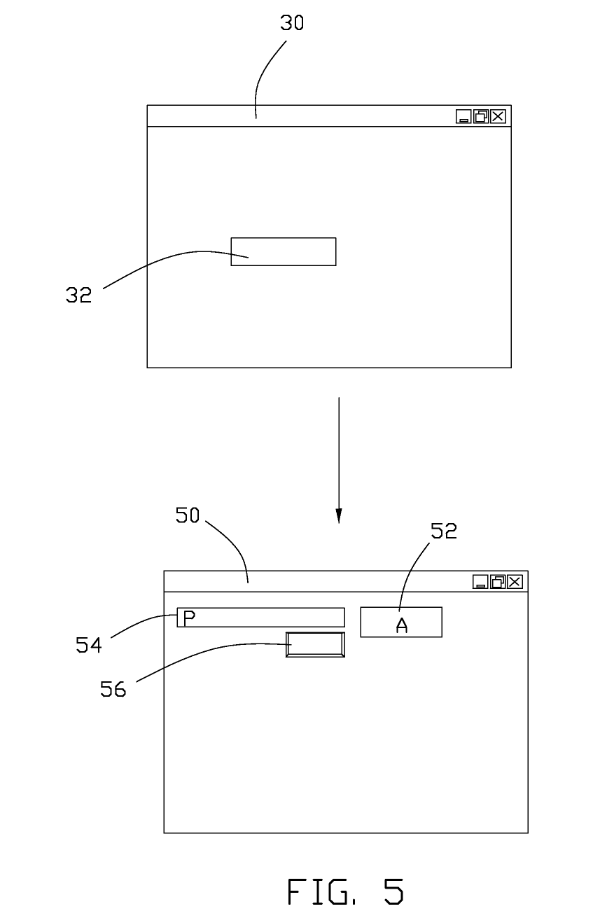

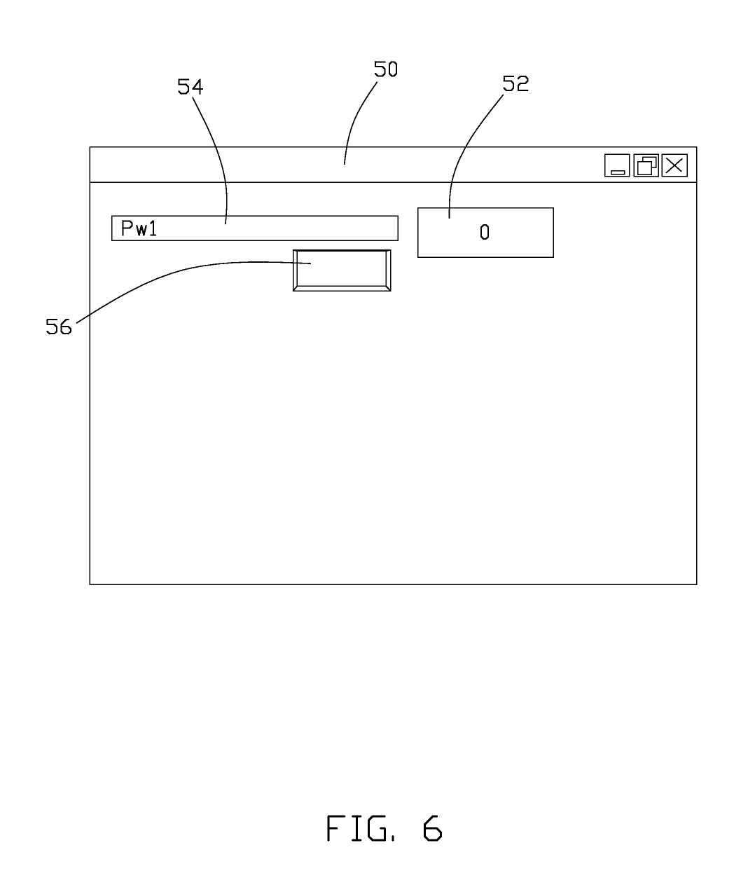

Referring to FIG. 5 and FIG. 6, in one embodiment, when a user wants to input sensitive information, such as a password “Pw1”, to an input window of an application interface, such as an input box 32 of a web page 30, by the mouse 20, a cursor is placed in the input box 32. The safety input program 100 is activated by the switch 21, and the input interface 50 pops up in the display of the computer 10. The cursor is moved into the character display box 52, an alphanumeric character appearing in the character display box 52 is switched to a uppercase format by signal-clicking the left button 22 one or several times, an uppercase alpha character “P” is selected from the uppercases A-Z by scrolling the scroll wheel 24, and is inputted into the character input box 54 by pressing down the scroll wheel 24.

Likewise, two following characters “w1” can be selected and inputted into the character input box 54 by operating the mouse 20. A wrong character inputted into the character input box 54 can be deleted by signal-clicking the right button 26. The cursor is moved onto the submitting button 56 after all characters of the password “Pw1” are inputted into the character input box 54, to transit the password “Pw1” to the input box 32 of the website 30 by single-clicking the left button 22. Therefore, the password can be safely inputted. The input interface 50 is closed to exit the safety input program 100, and the computer 10 can be used to carry out other operations. Due to all of characters are inputted into the input box 32 by the mouse 20 instead of a keyboard, hackers can not spy and extract the sensitive information easily. Therefore, safety of information inputted in the computer 10 is improved.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A system for inputting information, comprising:
a computer comprising a safety input program; and
a mouse connected to the computer;
wherein the safety input program comprises:
an interface popup module to pop up an input interface in response to the safety input program being activated, wherein the input interface comprises a character display box for display characters and a character input box;
a signal control module to process signals inputted in the character display box by the mouse, to select desired characters from the characters displayed in the character display box, and to input the selected characters into the character input box; and
a character output module to output characters input and displayed in the character input box to an input window of an application interface.

2. The system of claim 1, wherein the mouse comprises a left button, a scroll wheel, and right button.

3. The system of claim 2, wherein the signal control module comprises:
a left button input signal processing unit to process signals input in the character display box by the left button;
a scroll wheel input signal processing unit to process signals input in the character display box by the scroll wheel; and
a right button input signal processing unit to process signals input in the character display box by the right button.

4. The system of claim 3, wherein,
the left button input signal processing unit is to switch different kinds of the characters to be displayed in the character display box by clicking the character display box once via the left button;
the scroll wheel input signal processing unit is to switch different characters of a certain set of the characters to be displayed in the character display box by rolling the scroll wheel of the mouse, and to input a character currently displayed in the character display box into the character input box in response to pressing down the scroll wheel to select the currently displayed character; and
the right button input signal processing unit is to delete a last character input and displayed in the character input box in response to the right button clicking the character display box.

5. The system of claim 2, wherein the mouse further comprises a switch, the safety input program is activated by operating the switch.

6. The system of claim 1, wherein the characters comprise numerals 0-9, lowercases a-z, and uppercases A-Z, and the characters appear one after the other in the character display box randomly.

7. A method for inputting information, comprising:
starting a safety input program of a computer;
popping up an input interface by the safety input program, wherein the input interface comprises a character display box and a character input box;
receiving signals inputted in the character display box by a mouse, and processing the received signals to select desired characters from the character display box, and to input the selected characters into the character input box; and
outputting characters input and displayed in the character input box to an input window of an application interface.

8. The method of claim 7, wherein the mouse comprises a left button, a scroll wheel, and right button.

9. The method of claim 8, wherein processing the received signals comprises:
switching different kinds of the characters to be displayed in the character display box in response to clicking the character display box once via the left button;
switching different characters of a certain set of the characters to be displayed in the character display box in response to rolling the scroll wheel;
inputting a character currently displayed in the character display box into the character input box in response to pressing down the scroll wheel to select the currently displayed character; and
deleting a last character input and displayed in the character input box in response to clicking the character display box via the right button.

10. The method of claim 7, wherein the characters comprise numerals 0-9, lowercases a-z, and uppercases A-Z, and the characters appear one after the other in the character display box randomly.

11. The method of claim 7, wherein the computer further comprises a keyboard comprising a predetermined shortcut key, the safety input program is started by operating the shortcut key.

12. The method of claim 7, wherein the input interface further comprises a submitting button, characters input and displayed in the character input box are outputted to the input window of the application interface by clicking the submitting button via the mouse.
